(19) United States
(12) Patent Application Publication
(10) Pub. No.: US 2025/0101287 A1
(43) Pub. Date: Mar. 27, 2025

(54) MATERIAL, METHOD FOR MANUFACTURING MATERIAL, AND ELECTRONIC DEVICE

(71) Applicant: CANON KABUSHIKI KAISHA, Tokyo (JP)

(72) Inventors: YUICHIRO MIYAUCHI, Kanagawa (JP); SHIGERU ICHIHARA, Tokyo (JP)

(21) Appl. No.: 18/887,841

(22) Filed: Sep. 17, 2024

(30) Foreign Application Priority Data
Sep. 22, 2023 (JP) 2023-158917
Jun. 26, 2024 (JP) 2024-102831

(51) Int. Cl. C09K 5/14; C01G 31/02

(52) U.S. Cl. CPC C09K 5/14; C01G 31/02; C01P 2004/61

(57) ABSTRACT

A material includes a mixture of a plurality of particles formed containing a latent-heat material that causes solid-solid phase transition and a heat-conductive material having a higher heat conductivity than the latent-heat material. A volume fraction of the heat-conductive material in the material is 20% or more and less than 100%, and an average particle diameter of the particles is 0.1 μm or more and 40 μm or less.

### BACKGROUND

### Field

The present disclosure relates to a material, a method for manufacturing a material, and an electronic device.

### Description of the Related Art

In accordance with progress in artificial intelligence (AI) technology and extension in 5G technology, the density of heat (heat density) generated from electronic equipment increases. To maintain the performance of the electronic equipment, it is required to control the heat density in an appropriate range, and utilization of mainly two phenomena of heat transport and heat storage for controlling the heat density has been investigated. Herein, since the heat density locally increases, it is difficult to deal with by only increasing heat transport by using a material having a high heat conductivity. Consequently, storing of heat by using a heat storage material has attracted increasing attention.

On the other hand, in general, since the heat storage material has low heat dissipation performance, when excessive heat more than a heat storage capacity is applied, the temperature increases to a great extent. Therefore, to decrease the heat density of the electronic equipment while utilizing both the heat transport and the heat storage, use of a composite material of a material having a high heat conductivity and a heat storage material has been proposed.

For example, International Publication No. 2021/230357 discloses a solid heat storage material that is a bonded body in which vanadium dioxide serving as a solid heat storage material is in close adhesion to a high-heat-conductivity substance. In addition, Japanese Patent Laid-Open No. 2016-79351 discloses a composite heat storage material in which a heat storage material is dispersively mixed in an inorganic material.

However, in the composite material in the related art, since a heat-conductivity material is not efficiently distributed for contributing to heat dissipation, it is necessary that a large amount of heat-conductivity material is added, and it is difficult to ensure compatibility with heat storage.

### SUMMARY

Accordingly, in consideration of the above-described disadvantage, the present disclosure provides a material that efficiently dissipates heat and a method for manufacturing the same. In addition, the present disclosure provides an electronic device that efficiently dissipates heat.

In this regard, the invention is not limited to the above, and the disclosure according to the present specification provides, in addition to the above, operations and advantages which are derived from each configuration presented in DESCRIPTION OF THE EMBODIMENTS later and operations and advantages which are not obtained by the technology in the related art.

A material according to the present disclosure is a material in which a plurality of particles formed containing a latent-heat material that causes solid-solid phase transition and a heat-conductive material having a higher heat conductivity than the latent-heat material are mixed, wherein a volume fraction of the heat-conductive material in the material is 20% or more and less than 100%, and an average particle diameter of the particles is 0.1 μm or more and 40 μm or less.

Further features of the present disclosure will become apparent from the following description of exemplary embodiments with reference to the attached drawings.

### BRIEF DESCRIPTION OF THE DRAWINGS

FIG. 1 is a schematic diagram illustrating an example of the configuration of a material according to the present disclosure.

FIG. 2 is a schematic diagram illustrating an example of a method for manufacturing a material of Examples 1 to 4.

FIG. 3 is a scanning electron microscope (SEM) observation image of Example 1.

FIG. 4 is a graph illustrating an example of a radial distribution function of Example 1.

FIG. 5 is a schematic diagram illustrating an example of a manufacturing method of Comparative example 1.

FIG. 6 is a scanning electron microscope (SEM) observation image of a porous body of Example 5.

### DESCRIPTION OF THE EMBODIMENTS

The exemplary embodiments according to the present disclosure will be described below in detail with reference to the attached drawings. In this regard, the disclosure of the present specification is not limited to the following embodiments and may be variously modified (including organic combinations of each example) within the spirit and scope of the disclosure of the present specification, and these are not excluded from the scope of the disclosure of the present specification. That is, all configurations by combining each example described later and variation examples thereof are included in the embodiments disclosed in the present specification.

The present inventors examined the heat dissipation performance of a material (composite material) including both a latent-heat material serving as a heat storage material and a heat-conductive material having a higher heat conductivity than the heat storage material. As a result, it was found that the heat dissipation performance is improved when a volume fraction of the heat-conductive material in the composite material is 20% or more and less than 100%, and the latent-heat material is included as a plurality of particles having an average particle diameter of 0.1 μm or more and 40 μm or less.

In consideration of the above-described finding, the investigation was further performed, and it was found that the heat dissipation performance is particularly improved when the heat-conductive material and the latent-heat material form a sea-island structure in the composite material. Herein, the sea-island structure denotes a state in which one of two types of materials forms at least one isolated particle (island), and the other material forms a structure (sea) that surrounds the particle. In particular, it was made clear that the heat dissipation performance of a composite material having a sea-island structure in which the latent-heat material forms an island and the heat-conductive material forms a sea is high.

It is conjectured that the cause of the heat dissipation performance being improved by the configuration according to the present disclosure is as described below. The heat generated from a heat generating source is transported by the heat-conductive material, and the heat is transferred from the heat-conductive material to the latent-heat material so that the heat is stored in the latent-heat material. Therefore, the heat-conductive material having a continuous structure and the latent-heat material having a large total surface area enable heat dissipation to be efficiently performed.

### First Embodiment

A material according to the first embodiment is a material in which a plurality of particles formed containing a latent-heat material that causes solid-solid phase transition and a heat-conductive material having a higher heat conductivity than the plurality of particles containing the latent-heat material are mixed. The heat-conductive material and the latent-heat material being mixed enables a material having high heat dissipation performance while utilizing heat storage by the latent-heat material to be provided.

### Configuration of Material

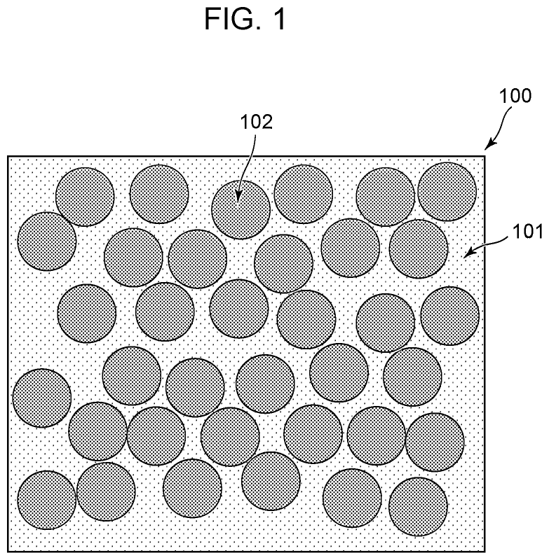

The configuration of the material according to the present embodiment will be described with reference to FIG. 1. FIG. 1 is a schematic diagram illustrating the configuration of the material according to the present embodiment and illustrates a cross section of the material according to the present embodiment.

A material 100 according to the present embodiment has a structure in which particles 102 formed containing the latent-heat material are substantially uniformly dispersed in a heat-conductive material 101 in any cross section. Herein, “substantially uniformly dispersed” denotes a state in which the radial distribution function of the particle 102 defined by g(r) of (Formula 1) below approaches 1.0 asymptotically at infinity (r→∞) although an aggregate may be partly formed.

g(r)=<nᵢ(r)/dV(r)> (Formula 1)

Herein, nᵢ(r) denotes the number of particles present between spherical shells at a distance r and a distance r+dr from a particle i, and dV(r) denotes the volume between the spherical shells. In addition, symbols < > in (Formula 1) means that nᵢ of each particle is estimated and an average is calculated. Therefore, the radial distribution function g(r) denotes the probability that another particle is present at a distance r from a particle.

In this regard, a minimum distance at which an absolute value of the radial distribution function takes a local maximum or maximum value is defined as a first neighbor distance. The average particle diameter of particles being smaller than a first neighbor distance of the radial distribution function in a structure in which the particles are substantially uniformly dispersed means that the particles are not in contact with each other in average.

That is, each particle is isolated in average and forms a so-called sea-island structure.

The volume fraction φ₁₀₁ of the heat-conductive material 101 according to the present embodiment in the material is determined from (Formula 2) and (Formula 3) below.

ρ₁₀₀=m₁₀₀/V₁₀₀ (Formula 2)

ρ₁₀₀=ρ₁₀₁φ₁₀₁+ρ₁₀₂(1−φ₁₀₁) (Formula 3)

Herein, m₁₀₀ denotes a mass of the material 100, V₁₀₀ denotes a volume of the material 100, ρ₁₀₀, ρ₁₀₁, and ρ₁₀₂ denote densities of the material 100, the heat-conductive material 101, and the particle 102, respectively. For example, the density of cupper is 8.9 (g/cm³), and the density of vanadium dioxide (VO₂) is 4.3 (g/cm³).

The particle 102 is formed containing a latent-heat material that causes solid-solid phase transition. It is sufficient that the latent-heat material is a material having large latent heat, such as vanadium oxide, trititanium pentoxide, dititanium trioxide, or titanium nickel. Of these, the latent-heat material can be an oxide material containing vanadium dioxide (VO₂). The oxide material can be V₁₋ₙMₙO₂ in which a portion of vanadium is substituted with an element M (M represents at least one selected from the group consisting of tungsten, chromium, molybdenum, niobium, tantalum, osmium, iridium, and ruthenium).

V₁₋ₙMₙO₂ is a material having a phase transition temperature that is changed in accordance with the type of the element M and the ratio n. Therefore, the phase transition temperature is adjusted to a temperature within a predetermined range by selecting the element M and the ratio n. For example, the phase transition temperature of vanadium dioxide is 68° C., and the phase transition temperature of V_{0.99}W_{0.01}O₂ (M=tungsten and n=0.01) is 39° C.

In addition, the phase transition temperature is also adjusted to a predetermined temperature by making the particle 102 a porous body. For example, although the phase transition temperature of vanadium dioxide is about 68° C., the phase transition temperature of porous vanadium dioxide formed by bringing vanadium dioxide particles having an average particle diameter of 200 nm into contact with each other is about 80° C. In this regard, it is conjectured that a change in the phase transition temperature caused by forming a porous body is due to distortion distribution in the particle 102 caused by the particle 102 having a pore structure in the interior.

In this regard, the shape of the particle 102 may be, other than spherical, rectangular or sub-rectangular or may be a mixture thereof. Alternatively, the particle may be a particle formed by two or more particles of spherical, rectangular, or the like being bonded to each other. When the particles 102 have shapes other than a spherical shape, the average particle diameter of the particle 102 is defined as an averaged diameters of spheres having the same volumes as the volumes of respective particles. When the average particle diameter is determined by a two-dimensional image (electron microscopic image) of an electron microscope or the like, the average particle diameter is defined as an averaged diameters (equivalent circle diameters) of circles having the same areas as the areas of the respective particles. From the viewpoint of improving heat dissipation performance, the average particle diameter of the particle 102 is preferably 0.1 μm or more and 100 μm or less, more preferably 0.1 μm or more and 20 μm or less, and further preferably 1 μm or more and 15 μm or less.

There is no particular limitation regarding the heat-conductive material 101 provided that the heat-conductive material 101 is a material having a higher heat conductivity than the latent-heat material (particle 102), and ceramics, metal materials, carbon materials, and the like are used. In particular, copper, aluminum, and the like can be used. The volume fraction of the heat-conductive material 101 in the material 100 is preferably 20% or more and less than 100% and further preferably 30% or more and 70% or less.

That is, the material according to the present disclosure is characterized in that the volume fraction of the heat-conductive material 101 is 20% or more and less than 100% and that the average particle diameter of the particle 102 (latent-heat material) is 0.1 μm or more and 100 μm or less.

Further, to enable efficient heat dissipation to be performed, the heat-conductive material 101 contained in the material 100 and the particle 102 containing the latent-heat material can form a sea-island structure. In particular, the heat-conductive material 101 forming a sea and the particle 102 forming an island in the sea-island structure enables efficient heat dissipation from the heat-conductive material 101 to the particle 102 to be performed so that the heat dissipation performance of the material 100 is improved.

Herein, when the heat-conductive material 101 and the particle 102 form a sea-island structure, the first neighbor distance of the radial distribution function of the particle 102 is larger than the average particle diameter of the particle 102 in a microscopic image (for example, a SEM image). That is, it is desirable for improving the heat dissipation performance by forming a sea-island structure that the first neighbor distance of the radial distribution function of the particle 102 is larger than the average particle diameter of the particle 102.

Further, as a result of the investigation by the present inventors, it was found that the heat-conductive material 101 and the particle 102 forming a sea-island structure and at least two particles 102 being located at a certain distance or more from each other improve the heat dissipation performance. That is, regarding the radial distribution function of a plurality of particles 102 in an electron microscopic image, the value of a first neighbor peak is preferably 1.1 or more and a value of the radial distribution function approaches preferably 1.0 asymptotically at a distance 2.0 times or more of the first neighbor distance to improve the heat dissipation performance.

In such an instance, to determine the first neighbor peak of the radial distribution function and the value approached asymptotically by (Formula 1), images of at least 500 particles have to be formed in the microscopic image. The number of particles is the number of specimens necessary when the standard deviation of the value of the radial distribution function calculated on a particle basis is assumed to be about 1.0, at least an absolute value of tolerance is assumed to be 0.1 or less, and the 95% confidence interval is assumed. The reason the standard deviation is assumed to be about 1.0 is that, when particles are arranged completely at random, the radial distribution function approaches 1.0 asymptotically. In addition, the reason at least an absolute value of tolerance is assumed to be 0.1 or less is that, when the first neighbor peak is 1.1, a peak 0.1 larger than the value of 1.0 approached asymptotically has to be detected.

### Operation

The material according to the present embodiment transports heat by the heat-conductive material 101 and stores heat by the latent-heat material in the particle 102. The heat-conductive material 101 being continuous enables heat to be efficiently transported, and, as a result, heat is efficiently dissipated. In this regard, the heat transported to the surface of the particle 102 by the heat-conductive material 101 is stored in the particle 102. Consequently, the heat stored in the particle 102 increases with increasing total surface area of the particle 102. Therefore, the quantity of heat stored increases with decreasing particle diameter of the particle 102. On the other hand, regarding, for example, vanadium dioxide, when the particle diameter is less than 0.1 μm, the phase transition temperature significantly increases, and the quantity of heat stored decreases from the quantity of heat stored at the original phase transition temperature. The decrease in the quantity of heat stored occurs when the average particle diameter is 1 μm or less.

As a result of the intensive investigation by the present inventors, it was found that the heat-conductive material 101 has a continuous structure when the volume fraction of the heat-conductive material 101 in the material 100 is 20% or more and less than 100% and that a large heat storage effect is exerted when the particle diameter of the particle 102 is 0.1 μm or more and 100 μm or less. Therefore, it was found that a material having high heat dissipation performance while utilizing heat storage by the latent-heat material is provided.

### Second Embodiment

A method for manufacturing the material according to the present disclosure will be described. A manufacturing method according to the present disclosure includes a mixing step of obtaining a mixture by mixing a metal particle containing copper and an oxide particle containing vanadium dioxide and a sintering step of sintering the mixture by performing heating. Herein, the average particle diameters of the metal particle and the oxide particle which are materials to be mixed being adjusted enables a material having a structure suitable for improving the heat dissipation performance to be produced. To produce a material having improved heat dissipation performance, a ratio of an average particle diameter of the oxide particle to an average particle diameter of the metal particle can be 5.0 or more.

### Third Embodiment

An electronic device according to the present disclosure is characterized by including a heat generating source and the material described in the first embodiment, wherein the heat generating source is in direct contact with the material or the heat generating source is in contact with the material with the heat-conductive material interposed therebetween. The material having high heat dissipation performance being brought into direct or indirect contact with the heat generating source enables the heat to be dissipated to the outside of the electronic device without concentrating the heat on the periphery of the heat generating source. Herein, it is sufficient that the heat generating source is a component to increase the temperature of the electronic device, and the heat generating source is, for example, a component of memory, CPU, or the like.

### EXAMPLES

The present disclosure will be described below in detail with reference to specific examples. In this regard, the invention is not limited to the configurations and forms of the following examples.

### Example 1

### Method for Manufacturing Material

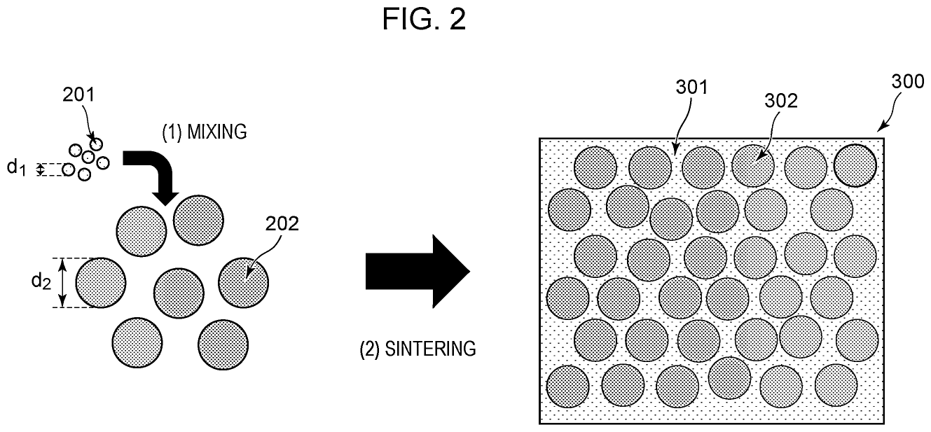

In the present example, a material illustrated in FIG. 2 was produced. An example of each production step will be described with reference to FIG. 2.

Initially, 15.8 g of copper particle (201) having an average particle diameter d₁ of 5 μm and 7.7 g of VO₂ particle (202) having an average particle diameter d₂ of 30 μm were prepared and mixed (FIG. 2 (1) Mixing). In such an instance, the ratio of the average particle diameter of the VO₂ particle 202 to the average particle diameter of the copper particle 201 was 30 μm/5 μm=6.0. The particle diameter of each particle before mixing was determined by a laser diffraction/scattering method. Subsequently, the particle mixture was placed in a circular cylindrical mold having a diameter of 30 mm, and sintering was performed by using a spark plasma sintering (SPS) apparatus so as to obtain a material 300 that was a sintered product (FIG. 2 (2) Sintering).

### Evaluation of Material

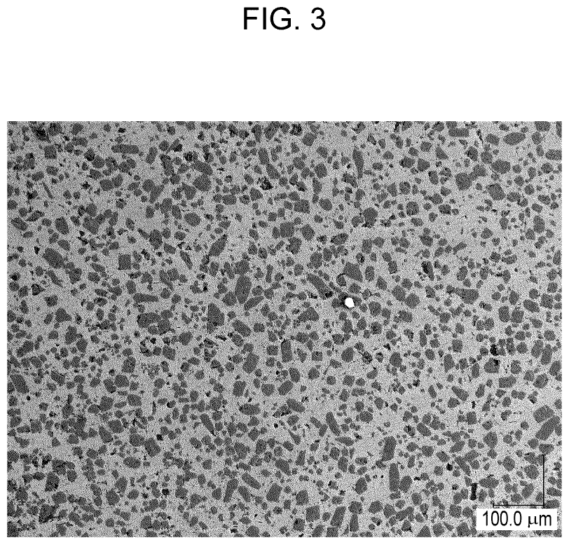

The size and the mass of the thus produced material 300 were measured. As a result, the average particle diameter was 30 mm, the average thickness was 4.8 mm, and the mass was 22.4 g. The density of the material 300 calculated from the obtained mass and the size (volume) by (Formula 2) was 6.6 g/cm³. In addition, the volume fraction of copper calculated using the calculated density of the material 300 and the densities of copper and VO₂ by (Formula 3) was 50%. A cross section of the obtained sample was observed using an electron microscope (FIG. 3). It was found by energy dispersive X-ray spectroscopy (SEM-EDX) that a portion with high luminance was VO₂, and a portion with low luminance was copper.

The observation image was binarized, and the barycenter and the area of each particle 302 were determined. A diameter (equivalent circle diameter) of a circle having the same area as the obtained area was determined, and the particle diameter of each particle 302 was determined. As a result, it was found that the average particle diameter was 10 μm and the maximum particle diameter was 50 μm or less. It is conjectured that the cause of the average particle diameter differing from the average particle diameter of the particle 202 before mixing is due to the particle diameter being estimated to be larger than the particle diameter in the observation image of the electron microscope since the density of the particle is increased during sintering and since an aggregated particles may be assumed as a particle by the laser diffraction/scattering method.

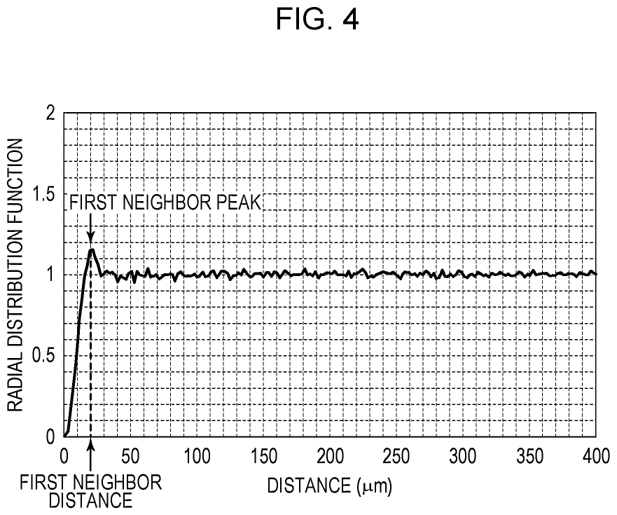

Further, a radial distribution function RDF was determined from (Formula 1) provided that each particle 302 is located at the barycentric coordinate of each particle. The result thereof is illustrated in FIG. 4. It was found that the first neighbor distance was 20 μm, and the value of the radial distribution function was 1.15 at the first neighbor peak and approached 1.0 asymptotically at a distance of 40 μm or more.

Accordingly, it was found that particles were concentrated up to the first neighbor distance at a number density about 1.1 times the average number density of particles of the entire material. Since the radial distribution function approached 1.0 asymptotically regarding the second and subsequent neighbors, it was found that this structure was substantially uniform dispersion. In addition, since the average particle diameter was 10 μm while the first neighbor distance was 20 μm, it was found that a sea-island structure was formed.

Regarding thermophysical property measurement, the heat conductivity was measured by a xenon flash method, and the latent heat was measured by differential scanning calorimetry (DSC). As a result, the heat conductivity was 120 W/mK, the latent heat was 103 J/cc, and the phase transition temperature was 69° C.

### Example 2

### Method for Manufacturing Material

In the present example, the material 300 was produced in the production step akin to that in Example 1 except that V_{0.99}W_{0.01}O₂ was used as the particle 202.

Initially, 17.4 g of copper particle having an average particle diameter of 5 μm and 8.5 g of V_{0.99}W_{0.01}O₂ particle having an average particle diameter of 30 μm were prepared and mixed. In such an instance, the ratio of the average particle diameter of the V_{0.99}W_{0.01}O₂ particle to the average particle diameter of the copper particle was 30 μm/5 μm=6.0. Subsequently, the particle mixture was placed in a circular cylindrical mold having a diameter of 30 mm, and sintering was performed by using a spark plasma sintering (SPS) apparatus so as to obtain the material 300 that was a sintered product.

### Evaluation of Material

The size and the mass of the thus produced material 300 were measured. As a result, the average particle diameter was 30 mm, the average thickness was 5.3 mm, and the mass was 24.6 g. The density of the material 300 calculated from the obtained mass and the size (volume) by (Formula 2) was 6.6 g/cm³. In addition, V_{0.99}W_{0.01}O₂ was sintered, the density thereof was measured, and it was found that the density was the same as the density of VO₂ and was 4.3 (g/cm³). The volume fraction of copper calculated using these results by (Formula 3) was 50%. A cross section of the obtained sample was observed using an electron microscope. The observation image was binarized, and the barycenter of each particle 302 and the area of each particle were determined.

A diameter of a circle having the same area as the obtained area was determined, and the particle diameter of each particle was determined. As a result, it was found that the average particle diameter was 10 μm and the maximum particle diameter was 50 μm or less. Further, the radial distribution function of a binarized image of the obtained observation image was determined, and it was found that the radial distribution function approached 1.0 asymptotically at a distance of 40 μm or more. Accordingly, it was found that this structure was substantially uniform dispersion. In addition, since the average particle diameter was 10 μm while the first neighbor distance was 20 μm, it was found that a sea-island structure was formed.

Regarding thermophysical property measurement, the heat conductivity was measured by a xenon flash method, and the latent heat was measured by differential scanning calorimetry (DSC). As a result, the heat conductivity was 117 W/mK, the latent heat was 76 J/cc, and the phase transition temperature was 40° C.

### Example 3

### Method for Manufacturing Material

In the present example, the material 300 was produced in the production step akin to that in Example 1 except that the volume fraction of the copper particle 201 was changed.

Initially, 9.0 g of copper particle having an average particle diameter of 5 μm and 10.1 g of VO₂ particle having an average particle diameter of 30 μm were prepared and mixed. In such an instance, the ratio of the average particle diameter of the VO₂ particle 202 to the average particle diameter of the copper particle 201 was 30 μm/5 μm=6.0. Subsequently, the particle mixture was placed in a circular cylindrical mold having a diameter of 30 mm, and sintering was performed by using a spark plasma sintering (SPS) apparatus so as to obtain the material 300 that was a sintered product.

### Evaluation of Material

The size and the mass of the thus produced material 300 were measured. As a result, the average particle diameter was 30 mm, the average thickness was 4.7 mm, and the mass was 18.9 g. The density of the material 300 calculated from the obtained mass and the size (volume) by (Formula 2) was 5.7 g/cm³. The volume fraction of copper calculated using these results by (Formula 3) was 30%. A cross section of the obtained sample was observed using an electron microscope. The observation image was binarized, and the barycenter of each particle 302 and the area of each particle were determined.

A diameter of a circle having the same area as the obtained area was determined, and the particle diameter of each particle was determined. As a result, it was found that the average particle diameter was 10 μm and the maximum particle diameter was 50 μm or less. Further, the radial distribution function of a binarized image of the obtained observation image was determined, and it was found that the radial distribution function approached 1.0 asymptotically at a distance of 30 μm or more. Accordingly, it was found that this structure was substantially uniform dispersion.

In addition, since the average particle diameter was 10 μm while the first neighbor distance was 17 μm, it was found that a sea-island structure was formed.

Regarding thermophysical property measurement, the heat conductivity was measured by a xenon flash method, and the latent heat was measured by differential scanning calorimetry (DSC). As a result, the heat conductivity was 67 W/mK, the latent heat was 144 J/cc, and the phase transition temperature was 69° C.

### Example 4

### Method for Manufacturing Material

In the present example, the material 300 was produced in the production step akin to that in Example 1 except that the volume fraction of the copper particle 201 was changed.

Initially, 22.1 g of copper particle having an average particle diameter of 5 μm and 4.6 g of VO₂ particle having an average particle diameter of 30 μm were prepared and mixed. In such an instance, the ratio of the average particle diameter of the VO₂ particle to the average particle diameter of the copper particle was 30 μm/5 μm=6.0. Subsequently, the particle mixture was placed in a circular cylindrical mold having a diameter of 30 mm, and sintering was performed by using a spark plasma sintering (SPS) apparatus so as to obtain the material 300 that was a sintered product.

### Evaluation of Material

The size and the mass of the thus produced material 300 were measured. As a result, the average particle diameter was 30 mm, the average thickness was 5.0 mm, and the mass was 26.5 g. The density of the material 300 calculated from the obtained mass and the size (volume) by (Formula 2) was 7.5 g/cm³. The volume fraction of copper calculated using these results by (Formula 3) was 70%. A cross section of the obtained sample was observed using an electron microscope. The observation image was binarized, and the barycenter of each particle 302 and the area of each particle were determined. A diameter of a circle having the same area as the obtained area was determined, and the particle diameter of each particle was determined.

As a result, it was found that the average particle diameter was 10 μm and the maximum particle diameter was 50 μm or less. Further, the radial distribution function of a binarized image of the obtained observation image was determined, and it was found that the radial distribution function approached 1.0 asymptotically at a distance of 50 μm or more. Accordingly, it was found that this structure was substantially uniform dispersion. In addition, since the average particle diameter was 10 μm while the first neighbor distance was 25 μm, it was found that a sea-island structure was formed.

Regarding thermophysical property measurement, the heat conductivity was measured by a xenon flash method, and the latent heat was measured by differential scanning calorimetry (DSC). As a result, the heat conductivity was 230 W/mK, the latent heat was 62 J/cc, and the phase transition temperature was 69° C.

### Example 5

### Method for Manufacturing Material

In the present example, the material 300 was produced in the production step akin to that in Example 1 except that a porous VO₂ particle was used as the particle 202.

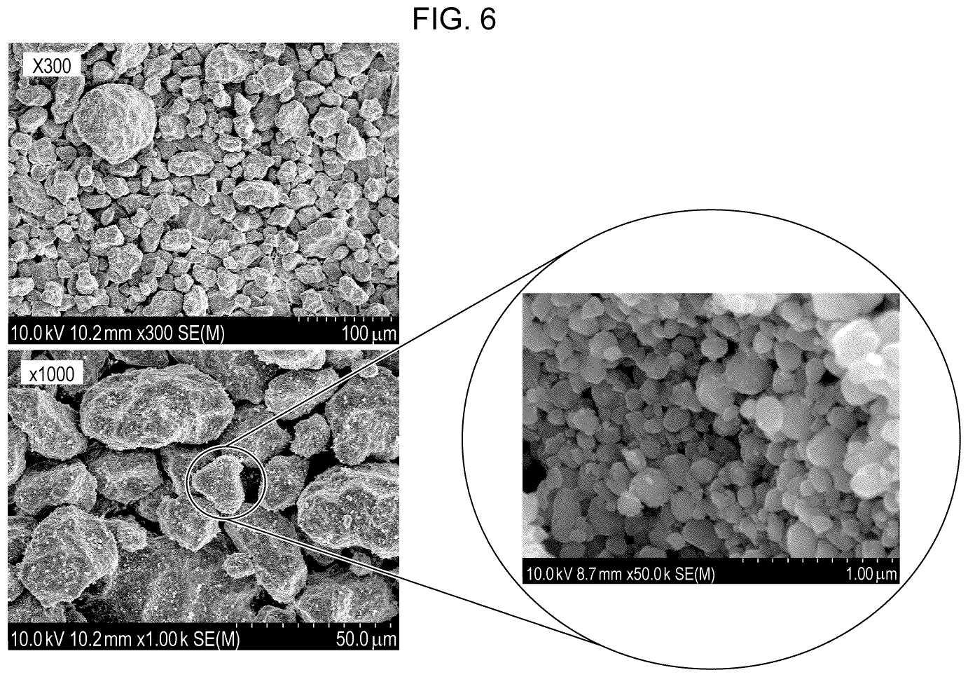

Initially, a porous VO₂ particle (FIG. 6) was obtained by subjecting a VO₂ particle having a particle diameter of 200 nm to a planetary ball mill (in air, 0.2 mm beads) and performing sieving with #125 mesh.

Thereafter, 4.6 g of obtained porous VO₂ particle having an average particle diameter of 30 μm and 15.8 g of copper particle having an average particle diameter of 5 μm were prepared and mixed. In such an instance, the ratio of the average particle diameter of the porous VO₂ particle to the average particle diameter of the copper particle was 30 μm/5 μm=6.0. Subsequently, the particle mixture was placed in a circular cylindrical mold having a diameter of 30 mm, and sintering was performed by using a spark plasma sintering (SPS) apparatus so as to obtain the material 300 that was a sintered product.

### Evaluation of Material

The size and the mass of the thus produced material 300 were measured. As a result, the average particle diameter was 30 mm, the average thickness was 4.9 mm, and the mass was 19.9 g. The density of the material 300 calculated from the obtained mass and the size (volume) by (Formula 2) was 5.7 g/cm³. In addition, the porous VO₂ particle was sintered, the density thereof was measured, and it was found that the density was 2.6 (g/cm³). The volume fraction of copper calculated using these results by (Formula 3) was 50%. A cross section of the obtained sample was observed using an electron microscope. The observation image was binarized, and the barycenter of each particle 302 and the area of each particle were determined.

A diameter of a circle having the same area as the obtained area was determined, and the particle diameter of each particle was determined. As a result, it was found that the average particle diameter was 10 μm and the maximum particle diameter was 50 μm or less. Further, the radial distribution function of a binarized image of the obtained observation image was determined, and it was found that the radial distribution function approached 1.0 asymptotically at a distance of 40 μm or more. Accordingly, it was found that this structure was substantially uniform dispersion. In addition, since the average particle diameter was 10 μm while the first neighbor distance was 20 μm, it was found that a sea-island structure was formed.

Regarding thermophysical property measurement, the heat conductivity was measured by a xenon flash method, and the latent heat was measured by differential scanning calorimetry (DSC). As a result, the heat conductivity was 100 W/mK, the latent heat was 58 J/cc, and the phase transition temperature was 80° C.

### Comparative Example 1

### Method for Manufacturing Material

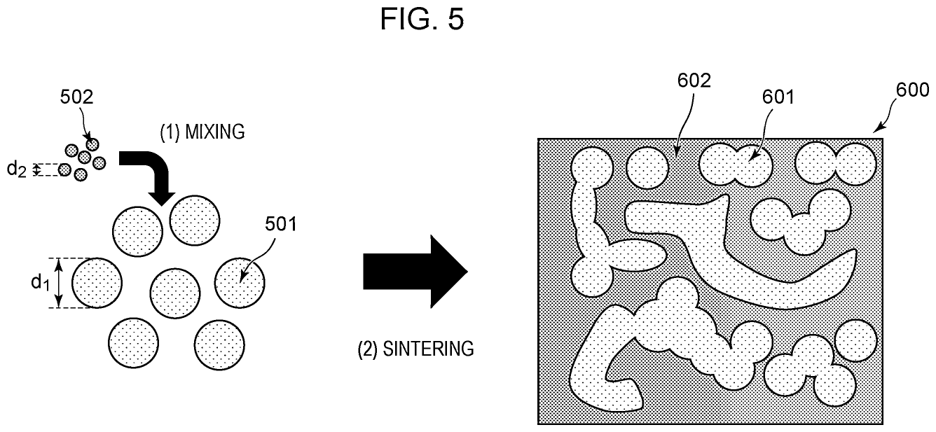

In the present comparative example, a material 600 was produced in the production step akin to that in Example 1 except that the ratio of the particle diameter of the VO₂ particle to the particle diameter of the copper particle was set to be less than 1. FIG. 5 is a schematic diagram illustrating the manufacturing method.

Initially, 15.0 g of copper particle having an average particle diameter of 30 μm and 7.3 g of VO₂ particle having an average particle diameter of 5 μm were prepared and mixed (FIG. 5 (1) Mixing). In such an instance, the ratio of the average particle diameter of the VO₂ particle 502 to the average particle diameter of the copper particle 501 was 5 μm/30 μm=0.17. Subsequently, the particle mixture was placed in a circular cylindrical mold having a diameter of 30 mm, and sintering was performed by using a spark plasma sintering (SPS) apparatus so as to obtain the material 600 that was a sintered product (FIG. 5 (2) Sintering).

### Evaluation of Material

The size and the mass of the thus produced material 600 were measured. As a result, the average particle diameter was 30 mm, the average thickness was 5.0 mm, and the mass was 23.0 g. The density of the material 600 calculated from the obtained mass and the size (volume) by (Formula 2) was 6.5 g/cm³. In addition, the volume fraction of copper calculated using the calculated density of the material 600 and the densities of copper and VO₂ by (Formula 3) was 48%.

A cross section of the obtained sample was observed using an electron microscope. It was found from the resulting observation image that the structure was a mixed-state structure in which the latent-heat material 602 did not form an island. Herein, “mixed state structure” means a state in which it is not clear whether the latent-heat material 602 or a heat-conductive material 601 forms a sea and whether the latent-heat material 602 or a heat-conductive material 601 forms an island. In particular, in the structure of Comparative example 1, the latent-heat material 602 did not form an island.

Regarding thermophysical property measurement, the heat conductivity was measured by a xenon flash method, and the latent heat was measured by differential scanning calorimetry (DSC). As a result, the heat conductivity was 70 W/mK, the latent heat was 97 J/cc, and the phase transition temperature was 69° C.

### Comparative Example 2

### Method for Manufacturing Material

In the present comparative example, the material 600 was produced in the production step akin to that in Comparative example 1 except that the volume fraction of the copper particle 501 was changed.

Initially, 9.6 g of copper particle having an average particle diameter of 30 μm and 10.7 g of VO₂ particle having an average particle diameter of 5 μm were prepared and mixed. In such an instance, the ratio of the average particle diameter of the VO₂ particle to the average particle diameter of the copper particle was 5 μm/30 μm=0.17. Subsequently, the particle mixture was placed in a circular cylindrical mold having a diameter of 30 mm, and sintering was performed by using a spark plasma sintering (SPS) apparatus so as to obtain the material 600 that was a sintered product.

### Evaluation of Material

The size and the mass of the thus produced material 600 were measured. As a result, the average particle diameter was 30 mm, the average thickness was 5.0 mm, and the mass was 20.1 g. The density of the material 600 calculated from the obtained mass and the size (volume) by (Formula 2) was 5.7 g/cm³. In addition, the volume fraction of copper calculated using the calculated density of the material 600 and the densities of copper and VO₂ by (Formula 3) was 30%. A cross section of the obtained sample was observed using an electron microscope. It was found from the resulting observation image that the structure was a mixed state structure in which the latent-heat material 602 did not form an island.

Regarding thermophysical property measurement, the heat conductivity was measured by a xenon flash method, and the latent heat was measured by differential scanning calorimetry (DSC). As a result, the heat conductivity was 30 W/mK, the latent heat was 120 J/cc, and the phase transition temperature was 69° C.

### Comparative Example 3

### Method for Manufacturing Material

In the present comparative example, the material 600 was produced in the production step akin to that in Comparative example 1 except that the volume fraction of the copper particle 501 was changed.

Initially, 22.1 g of copper particle having an average particle diameter of 30 μm and 4.6 g of VO₂ particle having an average particle diameter of 5 μm were prepared and mixed. In such an instance, the ratio of the average particle diameter of the VO₂ particle 502 to the average particle diameter of the copper particle 501 was 5 μm/30 μm=0.17. Subsequently, the particle mixture was placed in a circular cylindrical mold having a diameter of 30 mm, and sintering was performed by using a spark plasma sintering (SPS) apparatus so as to obtain the material 600 that was a sintered product (FIG. 5 (2) Sintering).

### Evaluation of Material

The size and the mass of the thus produced material 600 were measured. As a result, the average particle diameter was 30 mm, the average thickness was 5.0 mm, and the mass was 26.5 g. The density of the material 600 calculated from the obtained mass and the size (volume) by (Formula 2) was 7.5 g/cm³. In addition, the volume fraction of copper calculated using the calculated density of the material 600 and the densities of copper and VO₂ by (Formula 3) was 70%. A cross section of the obtained sample was observed using an electron microscope. It was found from the resulting observation image that the structure was a mixed state structure in which the latent-heat material 602 did not form an island.

Regarding thermophysical property measurement, the heat conductivity was measured by a xenon flash method, and the latent heat was measured by differential scanning calorimetry (DSC). As a result, the heat conductivity was 170 W/mK, the latent heat was 52 J/cc, and the phase transition temperature was 69° C.

### Comparative Example 4

### Method for Manufacturing Material

In the present comparative example, the material 300 was produced in the production step akin to that in Example 1 except that the volume fraction of the copper particle 201 was decreased to less than 20%.

Initially, 5.7 g of copper particle having an average particle diameter of 5 μm and 11.7 g of VO₂ particle having an average particle diameter of 30 μm were prepared and mixed. In such an instance, the ratio of the average particle diameter of the VO₂ particle to the average particle diameter of the copper particle was 30 μm/5 μm=6.0. Subsequently, the particle mixture was placed in a circular cylindrical mold having a diameter of 30 mm, and sintering was performed by using a spark plasma sintering (SPS) apparatus so as to obtain the material 300 that was a sintered product.

### Evaluation of Material

The size and the mass of the thus produced material 300 were measured. As a result, the average particle diameter was 30 mm, the average thickness was 4.6 mm, and the mass was 16.9 g. The density of the material 300 calculated from the obtained mass and the size (volume) by (Formula 2) was 5.2 g/cm³. The volume fraction of copper calculated using these results by (Formula 3) was 19%.

A cross section of the obtained sample was observed using an electron microscope. The observation image was binarized, and the barycenter of each particle 302 and the area of each particle were determined. A diameter of a circle having the same area as the obtained area was determined, and the particle diameter of each particle was determined. As a result, it was found that the average particle diameter was 10 μm and the maximum particle diameter was 50 μm or less. Further, the radial distribution function of a binarized image of the obtained observation image was determined, and it was found that the first neighbor distance was 10 μm. Since the average particle diameter was 10 μm while the first neighbor distance was 10 μm, it was found that the structure was a matrix-like structure in which particles 302 are successively connected to each other rather than a sea-island structure.

Regarding thermophysical property measurement, the heat conductivity was measured by a xenon flash method, and the latent heat was measured by differential scanning calorimetry (DSC). As a result, the heat conductivity was 15 W/mK, the latent heat was 5.3 J/cc, and the phase transition temperature was 69° C.

The above-described results are presented in Table.

TABLE 1
Structures and characteristics of Examples 1 to 5 and Comparative examples 1 to 4

| | | | | | Latent-heat | | | | |
|---|---|---|---|---|---|---|---|---|---|
| | Average | | Heat-conductive | | material | | | | |
| | particle | | material | | | Average | | | Phase |
| | diameter in | | | Volume | | particle | Heat | Latent | transition |
| | mixing step | Structure | | fraction | | diameter | conductivity | heat | temperature |
| | (oxide/metal) | of material | Material | [%] | Material | [μm] | [W/mK] | [J/cc] | [° C.] |
| Example 1 | 6.0 | sea-island | Cu | 50 | VO₂ | 10 | 120 | 103 | 69 |
| | | structure | | | | | | | |
| | | (sea = Cu) | | | | | | | |
| Example 2 | 6.0 | sea-island | Cu | 50 | V_{0.99} W_{0.01}O₂ | 10 | 117 | 76 | 40 |
| | | structure | | | | | | | |
| | | (sea = Cu) | | | | | | | |
| Example 3 | 6.0 | sea-island | Cu | 30 | VO₂ | 10 | 67 | 144 | 69 |
| | | structure | | | | | | | |
| | | (sea = Cu) | | | | | | | |
| Example 4 | 6.0 | sea-island | Cu | 70 | VO₂ | 10 | 230 | 62 | 69 |
| | | structure | | | | | | | |
| | | (sea = Cu) | | | | | | | |
| Example 5 | 6.0 | sea-island | Cu | 50 | VO₂ porous | 10 | 100 | 58 | 80 |
| | | structure | | | body | | | | |
| | | (sea = Cu) | | | | | | | |
| Comparative | 0.17 | mixed state | Cu | 48 | VO₂ | — | 70 | 97 | 69 |
| example 1 | | (not clear | | | | | | | |
| | | sea-island | | | | | | | |
| | | structure) | | | | | | | |
| Comparative | 0.17 | mixed state | Cu | 30 | VO₂ | — | 30 | 120 | 69 |
| example 2 | | (not clear | | | | | | | |
| | | sea-island | | | | | | | |
| | | structure) | | | | | | | |
| Comparative | 0.17 | mixed state | Cu | 70 | VO₂ | — | 170 | 52 | 69 |
| example 3 | | (not clear | | | | | | | |
| | | sea-island | | | | | | | |
| | | structure) | | | | | | | |
| Comparative | 6.0 | mixed state | Cu | 19 | VO₂ | 10 | 15 | 5.3 | 69 |
| example 4 | | (not clear | | | | | | | |
| | | sea-island | | | | | | | |
| | | structure) | | | | | | | |

As presented in Table, when the heat conductivities of materials including the same volume fraction of heat-conductive material are compared, Example was always larger than Comparative example. That is, even when the volume fraction of the heat-conductive material is constant, the configuration according to the present disclosure enables the heat conductivity to be improved so that the heat dissipation performance is improved. In other words, regarding the material according to the present disclosure, the volume fraction of the heat-conductive material being 20% or more and less than 100% and the average particle diameter of the particle being 0.1 μm or more and 100 μm or less enable the heat dissipation performance of the material containing the latent-heat material to be improved.

The embodiments and the examples of the present disclosure have been specifically described, but the invention is not limited to the above-described embodiments. The present disclosure may be variously modified based on the technical concept. For example, the numerical values and the constructional elements described in the above-described embodiments are no more than exemplifications. As the situation demands, numerical values and constructional elements that differ from these may be used.

Using the materials according to the above-described embodiments and examples enables compatibility between heat dissipation and heat storage to be ensured since the heat dissipation performance higher than that of known latent-heat materials is obtained. Therefore, since heat is dissipated without separately disposing a heat path for heat dissipation, heat-controlling devices (heat sinks, heat storage devices, and the like) are downsized. For example, the materials are used for heat control of small 5G devices, edge AI devices, and IoT equipment. In addition, uses for heat-controlling devices of high-density heat sources of video cameras with high heat density and high definition such as 8K and 12K, medical equipment by using X-rays, automobile and railway vehicles, industrial equipment and business machines, high-performance computing systems, and the like are expected. In this regard, the present disclosure enables the heat dissipation performance of the heat storage material to be improved and, therefore, is applicable to wide range of fields other than the above-described fields.

The disclosure of the present embodiment includes the following configurations and a method.

According to the present disclosure, a material that efficiently dissipates heat and a method for manufacturing the same are provided. In addition, an electronic device that efficiently dissipates heat is provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-158917, filed Sep. 22, 2023 and No. 2024-102831 filed Jun. 26, 2024, which are hereby incorporated by reference herein in their entirety.

What is claimed is:

1. A material, comprising:
a plurality of particles formed containing a latent-heat material that causes solid-solid phase transition; and
a mixture including a heat-conductive material and the plurality of particles, wherein the heat-conductive material has a higher heat conductivity than the latent-heat material,
wherein a volume fraction of the heat-conductive material in the material is 20% or more and less than 100%, and
an average particle diameter of the plurality of particles is 0.1 μm or more and 40 μm or less.

2. The material according to claim 1,
wherein the volume fraction of the heat-conductive material in the material is 30% or more and 70% or less.

3. The material according to claim 1,
wherein the latent-heat material is an oxide material containing vanadium dioxide.

4. The material according to claim 3,
wherein the oxide material contains at least one member selected from a group consisting of tungsten, chromium, molybdenum, niobium, tantalum, osmium, iridium, and ruthenium.

5. The material according to claim 1,
wherein the plurality of the particles has a pore structure in an interior.

6. The material according to claim 1,
wherein the heat-conductive material and the plurality of particles form a sea-island structure.

7. The material according to claim 1,
wherein the heat-conductive material and the plurality of particles form a sea-island structure in which the heat-conductive material is a sea and the plurality of particles are islands.

8. The material according to claim 1,
wherein a first neighbor distance of a radial distribution function of the plurality of particles in an electron microscope image is larger than an average particle diameter of the plurality of particles in the electron microscope image.

9. The material according to claim 8,
wherein, regarding the radial distribution function of the plurality of particles in an electron microscope image, a value of the radial distribution function approaches 1.0 asymptotically at a distance 2.0 times or more of the first neighbor distance.

10. The material according to claim 8,
wherein, regarding the radial distribution function of the plurality of particles in an electron microscope image, a value of a first neighbor peak is 1.1 or more, and a value of the radial distribution function approaches 1.0 asymptotically at a distance 2.0 times or more of the first neighbor distance.

11. An electronic device comprising:
a plurality of particles formed containing a latent-heat material that causes solid-solid phase transition; and
a mixture including a heat-conductive material and the plurality of particles, wherein the heat-conductive material has a higher heat conductivity than the latent-heat material,
wherein a volume fraction of the heat-conductive material in the material is 20% or more and less than 100%,
an average particle diameter of the plurality of particles is 0.1 μm or more and 40 μm or less, and
the material is in contact with a heat generating source directly or with a heat-conductive material interposed therebetween.

12. A method for manufacturing a material comprising:
mixing a metal particle containing copper and an oxide particle containing vanadium dioxide; and
sintering the mixture by performing heating,
wherein a ratio of an average particle diameter of the oxide particle to an average particle diameter of the metal particle is 5.0 or more.
